(19) United States
(12) Patent Application Publication
(10) Pub. No.: US 2009/0027923 A1
(43) Pub. Date: Jan. 29, 2009

(54) POWER SUPPLY DEVICE AND POWER SUPPLY CONTROL METHOD

(75) Inventor: Yasuhiro IINO, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/240,206

(22) Filed: Sep. 29, 2008

Related U.S. Application Data
(63) Continuation of application No. PCT/JP2006/306671, filed on Mar. 30, 2006.

(51) Int. Cl. H02M 3/335

(52) U.S. Cl. 363/17

(57) ABSTRACT

A power supply device includes input terminals, output terminals, a main transformer having a primary winding and secondary windings, a primary circuit connected between the input terminals and the primary winding of the main transformer, a secondary circuit connected between the secondary windings of the main transformer 5 and the output terminals, and an impedance conversion circuit. The impedance conversion circuit is provided in the primary circuit, connected in series to the primary winding of the main transformer, and has a function reducing a current flowing therein and a function cutting a DC component included in the reduced current. The impedance conversion circuit has a transformer, and a capacitor connected in series to a secondary winding of the transformer.

### CROSS REFERENCE TO RELATED APPLICATIONS

This is a continuation application of PCT application serial number PCT/JP2006/306671, filed on Mar. 30, 2006.

### BACKGROUND OF THE INVENTION

1. Field of the Invention

An embodiment of the present invention relates to a power supply device and a power supply control method, which may include a large capacity (high current and high voltage) power supply device and a large capacity power supply control method preventing a biased excitation in a transformer.

2. Description of the Related Art

For example, in a power supply device like a full-bridge converter, as shown in FIG. 6, a capacitor 109 is connected in series to a primary winding of a transformer 105, so that a DC component is cut to prevent a biased excitation in the transformer 105.

In a circuit on a primary side of the full-bridge converter in FIG. 6, a current flows along a route “a” shown by solid line arrows in an application period of a positive half-wave (in the case of a positive side in FIG. 4A). That is, the current flows a power supply 104 (Vin(+)), an input terminal 101, a semiconductor switch 133, the transformer (main transformer) 105, the capacitor 109, a semiconductor switch 132, an input terminal 101, and a power supply 104 (Vin(−)), in the order described above. On the other hand, a current flows along a route “b” shown by dotted line arrows in an application period of a negative half-wave (in the case of a negative side in FIG. 4A). That is, the current flows the power supply 104 (Vin(+)), the input terminal 101, a semiconductor switch 131, the capacitor 109, the transformer 105, a semiconductor switch 134, the input terminal 101, and the power supply 104 (Vin(−)), in the order described above. Accordingly, the capacitor 109 cuts a DC component, and therefore, a biased excitation in the transformer 105 can be prevented.

It is known that an inverter is controlled so that a correction quantity for suppressing a DC component due to a biased excitation by an output current of the inverter can be used for suppressing a DC component flowing on an AC output side of the inverter, even though a biased excitation occurs (see Patent document 1: Japanese Patent Laid-Open No. 08-223944).

It is also known that a high efficiency conversion with a simple structure is performed by providing a series circuit of a primary winding of a transformer and a resonant capacitor at a middle point between two pairs of series circuits including switching elements (see Patent document 2: Japanese Patent Laid-Open No. 10-136653).

We examined a power supply device (full-bridge converters) as shown in FIG. 6, and found problems described below. That is, as described above, all the currents which flows through the primary winding of the main transformer 105 (primary currents) flow to the capacitor 109. Then, along with an increasing of capacity of the power supply device, the current increases which flows into the capacitor 109. However, the capacitor 109 has a limit in its current (permissible ripple current) and its withstand voltage. The use over the limit of the permissible ripple current or the withstand voltage is impossible in view of safety. Further, it is difficult to increase the permissible ripple current and the withstand voltage of the capacitor 109, and great improvement on these cannot be desired much. In particular, it is almost impossible to increase the permissible ripple current of the capacitor 109. Accordingly, a method for preventing a biased excitation in the main transformer 105 by the capacitor 109 is not suitable for large capacity power supply devices. That is, it cannot be said that the power supply device shown in FIG. 6 is suitable for large capacity power supply devices.

### SUMMARY OF THE INVENTION

One aspect of an object of the present invention is to provide a large capacity power supply device which can be operated in stable by preventing a biased excitation in a main transformer.

Another aspect of an object of the present invention is to provide a large capacity power supply control method which can be operated in stable by preventing a biased excitation in a main transformer.

A power supply device of an embodiment of the present invention includes an input terminal, an output terminal, a main transformer having a primary winding and a secondary winding, a primary circuit connected between the input terminal and the primary winding of the main transformer, a secondary circuit connected between the secondary winding of the main transformer and the output terminal, and an impedance conversion circuit. The impedance conversion circuit is provided in the primary circuit, is connected in series to the primary winding of the main transformer, and has a function reducing a current flowing in the impedance conversion circuit and a function cutting a DC component included in the reduced current.

The impedance conversion circuit of an embodiment of the present invention includes a transformer or a current transformer having a primary winding which is connected in series to the primary winding of the main transformer, and a capacitor connected in series to a secondary winding of the transformer or a current transformer.

The transformer or current transformer of an embodiment of the present invention includes a transformer, and an equivalent capacity of the capacitor is determined by a turns ratio of the primary winding to the secondary winding of the transformer.

The transformer or current transformer of an embodiment of the present invention includes an impedance converter which comprises semiconductor elements.

A power supply control method of an embodiment of the present invention is a power supply control method in a power supply device having a primary circuit connected between an input terminal and a primary winding of a main transformer, a secondary circuit connected between a secondary winding of the main transformer and an output terminal, and an impedance conversion circuit provided in the primary circuit and connected in series to the primary winding of the main transformer. The method includes reducing, when a current flows from the primary winding of the main transformer to the impedance conversion circuit, by the impedance conversion circuit a current flowing therein, and cutting a DC component included in the reduced current.

According to the power supply device of an embodiment of the present invention, the impedance conversion circuit is used which is connected in series to the primary winding of the main transformer, reduces the current flowing therein, and cuts a DC component included in the reduced current. Then, the DC component can be cut, even though a large current flows through the primary winding of the main transformer. As a result, it is possible to certainly cut the DC component, and prevent a biased excitation in the main transformer.

Additionally, according to an embodiment of the present invention, the impedance conversion circuit has a transformer or current transformer connected in series to the primary winding of the main transformer, and a capacitor connected in series to the secondary winding of the transformer. Then, a function of an impedance conversion in the transformer or current transformer can make a capacity of the capacitor equivalently large in the case of viewing from a primary side in the main transformer. As a result, even a capacitor having a permissible ripple current which is not so large can cut the DC component included in a large current, and prevent the biased excitation in the main transformer.

Additionally, according to an embodiment of the present invention, an equivalent capacity of the capacitor is determined by a turns ratio of the primary winding to the secondary winding of the transformer, which constitutes the transformer or current transformer. Then, the capacity of the capacitor can be accurately determined, and also a tolerance of the current which flows through the primary side of the main transformer can be accurately determined.

Additionally, according to the embodiment of the present invention, the impedance conversion circuit has an impedance converter including the semiconductor elements. Then, instead of the transformer or current transformer, a function for an impedance conversion in the impedance converter can make the capacity of the capacitor equivalently large, so that even the capacitor having a permissible ripple current which is not so large can prevent the biased excitation in the main transformer.

According to the power supply control method of an embodiment of the present invention, when a current flows from the primary winding of the main transformer to the impedance conversion circuit, the impedance conversion circuit reduces the current, and cuts a DC component included in the reduced current. Then, the DC component can be cut, even though a large current flows through the primary winding of the main transformer. As a result, it is possible to certainly cut the DC component, prevent the biased excitation in the main transformer, and realize a large capacity power supply device which prevents the biased excitation in the main transformer.

### BRIEF DESCRIPTION OF THE DRAWINGS

FIG. 1 is a diagram showing a structure example of a power supply device of the present invention.

FIGS. 2A and 2B show diagrams illustrating an impedance conversion circuit.

FIG. 3 is a diagram explaining an operation of the power supply device in FIG. 1.

FIGS. 4A to 4C mainly show waveforms of the power supply device in FIG. 1.

FIG. 5 is a diagram showing another structure example of the power supply device of the present invention.

FIG. 6 is a diagram explaining a conventional power supply device.

### DETAILED DESCRIPTION OF THE PREFERRED EMBODIMENTS

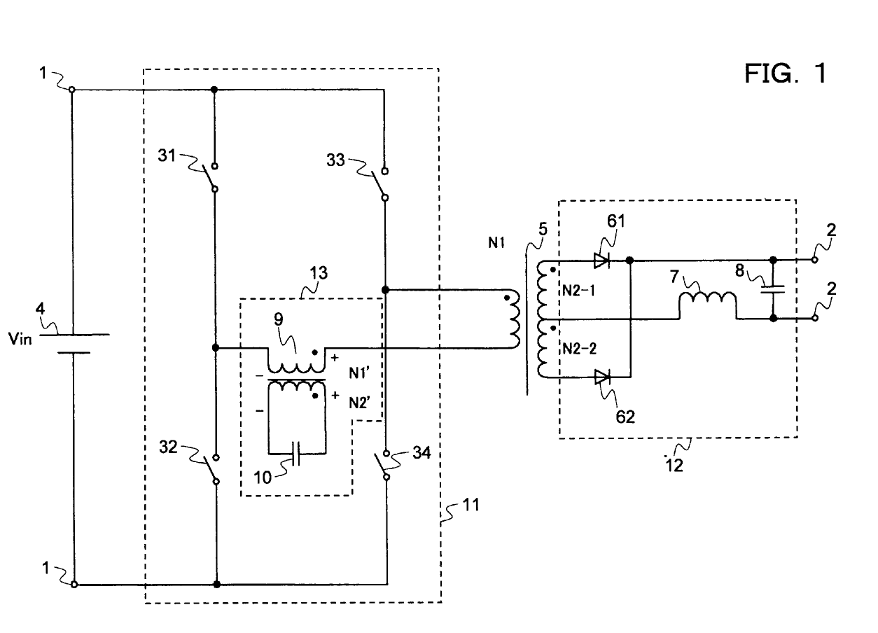

FIG. 1 is a block diagram of a power supply device showing a structure of the power supply device according to one embodiment of the present invention. The power supply device comprises input terminals 1, output terminals 2, a main transformer 5, a primary circuit 11, a secondary circuit 12, and an impedance conversion circuit 13. The main transformer 5 has a primary winding N1, and secondary windings N2-1 and N2-2. The impedance conversion circuit 13 is provided in the primary circuit 11. Reference character N1 also denotes the number of turns of the primary winding. Reference characters N2-1 and N2-2 are the same.

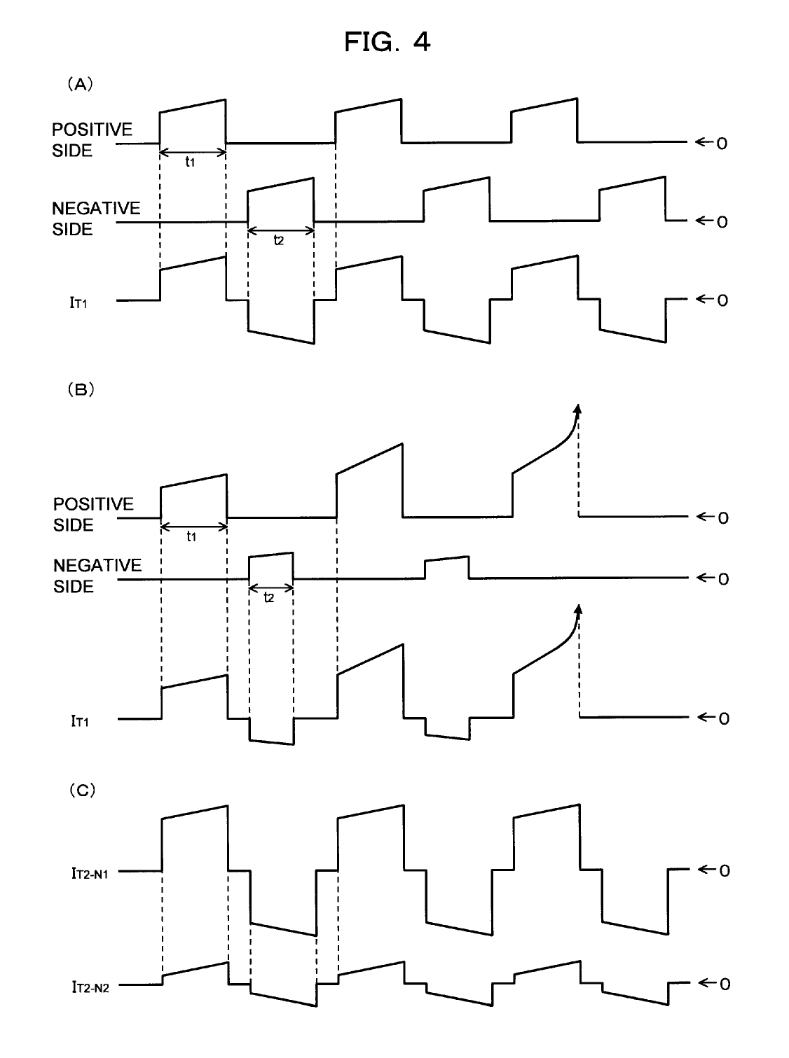

There are provided a plurality of the input terminals 1 (i.e. two input terminals). A power supply 4 is connected between the input terminals 1. The power supply 4 supplies a power having voltage waveforms shown in FIG. 4A described below, for example, to the power supply device. The power supply 4 is not limited thereto, and various power supplies may be used.

The primary circuit (input circuit) 11 is connected between the input terminals 1 and the primary winding N1 of the main transformer 5. The primary circuit 11 comprises a bridge circuit which is composed of a first to a fourth switching elements, for example, semiconductor switches 31 to 34. The first semiconductor switch 31 and the second semiconductor switch 32 are connected in series in the order described above, so that they constitute a first series circuit. The third semiconductor switch 33 and the fourth semiconductor switch 34 are connected in series in the order described above, so that they constitute a second series circuit. The first and the second series circuits are connected in parallel, and inserted between the input terminals 1.

The semiconductor switches 31 to 34 comprise well-known semiconductor elements such as MOSFETs, IGBTs, BJTs, SITs, thyristors, and GTOs for electric power. A predetermined control signal is supplied to respective control electrodes (gate electrodes or base electrodes) of the semiconductor switches 31 to 34 from a control circuit (not shown). Then, ON/OFF controls of the semiconductor switches 31 to 34 are performed so as to basically correspond to amplitude variation of an output of the power supply 4.

The impedance conversion circuit 13 is connected in series to the primary winding N1 of the main transformer 5. The impedance conversion circuit 13 has a function reducing a current generated therein (or flowing therein) (i.e. a function converting an impedance), and a function cutting a DC component included in the reduced current (i.e. a function cutting a direct current). Accordingly, when a current flows from the primary winding N1 of the main transformer 5 to the impedance conversion circuit 13, the impedance conversion circuit 13 reduces this current, and cuts a DC component included in the reduced current.

In this example, the impedance conversion circuit 13 comprises a transformer 9 having a primary winding N1′ which is connected in series to the primary winding N1 of the main transformer 5, and a capacitor 10 connected in series to a secondary winding N2′ of the transformer 9. Thus, it can be considered that the capacitor 10 is connected to the primary winding N1 of the main transformer 5 through the transformer 9. The transformer 9 originally has a function converting an impedance, and the capacitor 10 originally has a function cutting a direct current. The function converting an impedance may be realized by using a current transformer 9 instead of the transformer 9.

One terminal of the primary winding N1 of the main transformer 5 is connected to a connection point (middle point) of the first semiconductor switch 31 and the second semiconductor switch 32, both of which are connected in series, through the impedance conversion circuit 13. The other terminal of the primary winding N1 of the main transformer 5 is connected to a connection point (middle point) of the third semiconductor switch 33 and the fourth semiconductor switch 34, both of which are connected in series.

The secondary circuit (output circuit) 12 is connected between the secondary windings N2-1 and N2-2 of the main transformer 5 and output terminals 2. There are provided a plurality of the output terminals 2 (i.e. two output terminals). A DC voltage as an output of the power supply device is outputted between the output terminals 2. The secondary circuit 12 comprises diodes 61 and 62, an inductance 7, and a capacitor 8. The diodes 61 and 62 may be composed of well-known MOSFETs, IGBTs, SITs or the like, instead of diodes. An output voltage of the main transformer 5 is outputted to one output terminal 2 through the diodes 61 and 62 connected to respective terminals of the secondary windings N2-1 and N2-2 of the main transformer 5. The other output terminal 2 is connected to a middle point between the secondary windings N2-1 and N2-2 of the main transformer 5. That is, the secondary winding N2 of the main transformer 5 is divided into two parts at the middle point so that a turns ratio of its first part N2-1 is equal to that of its second part N2-2. The inductance 7 and the capacitor 8 constitute a smoothing circuit, and the smoothing circuit is inserted between the output terminals 2. Thus, the output voltage of the main transformer 5 is rectified, and smoothed.

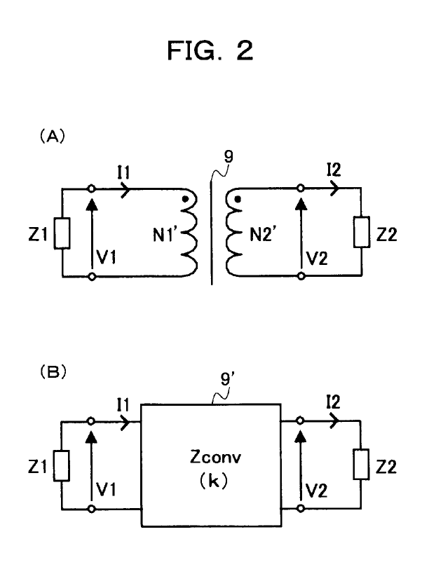

FIG. 2A is a diagram explaining the impedance conversion circuit 13. As described above, the impedance conversion circuit 13 comprises the transformer 9 and the capacitor 10. In this example, the transformer or current transformer 9 comprises a transformer 9, and an equivalent capacity of the capacitor 10 is determined by a turns ratio of the primary winding N1′ to the secondary winding N2′ of the transformer 9.

That is, as shown in FIG. 2A, it can be considered that an equivalent impedance Z1 of the primary winding N1 of the main transformer 5 is connected to the primary winding N1′ of the transformer 9, and that an equivalent impedance Z2 of the capacitor 10 is connected to the secondary winding N2′ of the transformer 9. At this time, voltages and currents are generated as shown in FIG. 2A.

In this case, we have the relations V1/V2=N1′/N2′ and I2/I1=N1′/N2′, so that V1=(N1′/N2′)·V2 and I1=(N2′/N1′)·I2 are obtained. Therefore, we get Z1=V1/I1=((N1′/N2′)·V2)/((N2′/N1′)·I2)=((N1′/N2′)·V2) (N1′/(N2′·I2))=(N1′/N2′)²·(V2/I2)=(N1′/N2′)²·Z2. That is, Z1=kZ2 (where k=(N1′/N2′)²) is established.

Accordingly, in this example, the number of turns N2′ of the secondary winding of the transformer 9 is set to be larger than the number of turns N1′ of the primary winding of the transformer 9. Then, the voltage V2 on a secondary side (i.e. capacitor 10) becomes higher, while the current I2 on the secondary side can be reduced. Additionally, it is possible to show an equivalent impedance of the capacitor 10 as if it is the value Z1 larger than the actual impedance Z2.

In this manner, a primary current of the main transformer 5 is reduced and supply to the capacitor 10 by connecting the capacitor 10 through the transformer 9 and by using the turns ratio of the transformer 9. That is, a capacity of the capacitor 10 from a view of a primary side (input side) in the transformer 9 is made equivalently large depending on the turns ratio of the transformer 9. Then, even though the primary current of the main transformer 5 is large, the current which flows to the capacitor 10 can be reduced. As a result, it is possible to prevent a biased excitation in a bridge converter performing a large capacity power conversion.

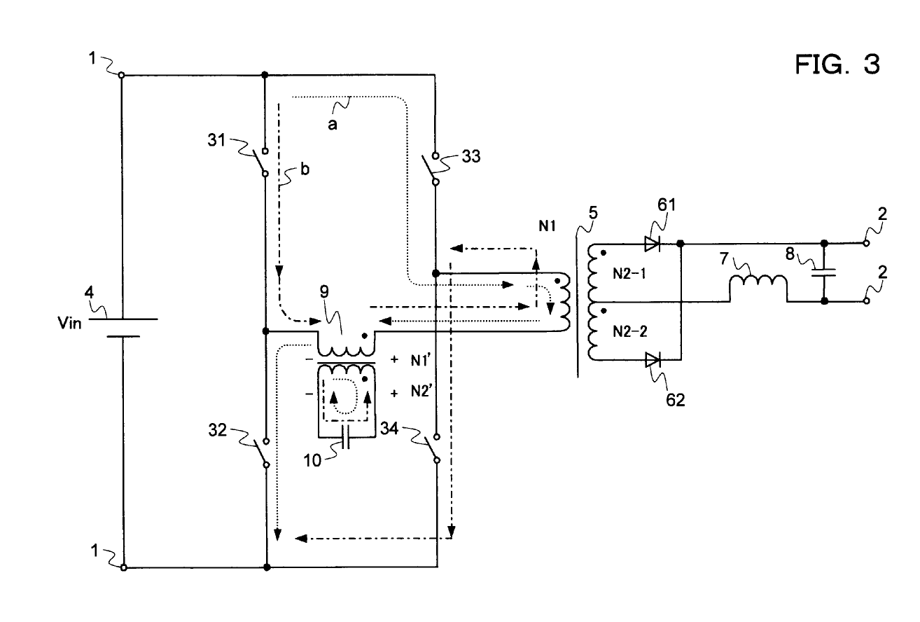

FIG. 3 is a diagram explaining an operation of the power supply device in FIG. 1. In FIG. 3, reference numerals 11 to 13 are omitted for simplification of the diagram.

Initially, described is an operation of a positive half-wave in the power supply device of FIG. 1 to which the power supply 4 (Vin) is inputted. In this case, the semiconductor switches 32 and 33 are turned on (ON) by a control signal from a control circuit (not shown). Simultaneously, the semiconductor switches 31 and 34 are not turned on (OFF). As a result, a route shown by a dotted line “a” is formed in FIG. 3, and a current flows to this route.

That is, the current flows the power supply 4 (Vin(+)), the input terminal 1, the semiconductor switch 33, the primary winding N1 of the main transformer 5, the primary winding N1′ of the transformer 9, the semiconductor switch 32, the input terminal 1, and the power supply 4 (Vin(−)), in the order described above. At this time, a voltage is simultaneously induced in a winding direction at the secondary winding N2′ of the transformer 9, and a current flows which depends on the turns ratio of the transformer 9 as described above, thereby charging the capacitor 10.

Next, described is an operation of a negative half-wave in the power supply device of FIG. 1 to which the power supply 4 (Vin) is inputted. In this case, the semiconductor switches 31 and 34 are turned on (ON) by the control signal from the control circuit (not shown). Simultaneously, the semiconductor switches 32 and 33 are not turned on (OFF). As a result, a route shown by an alternate long and short dashed line “b” is formed in FIG. 3, and a current flows to this route.

That is, the current flows the power supply 4 (Vin(+)), the input terminal 1, the semiconductor switch 31, the primary winding N1′ of the transformer 9, the primary winding N1 of the main transformer 5, the semiconductor switch 34, the input terminal 1, and the power supply 4 (Vin(−)), in the order described above. At this time, a voltage is simultaneously induced in an opposite direction of the winding direction (or an opposite direction compared with the case of the positive half-wave) in the secondary winding N2′ of the transformer 9, and a current flows which depends on the turns ratio of the transformer 9, thereby discharging and charging the capacitor 10.

Accordingly, the capacitor 10 is charged and discharged through the transformer 9 in the primary circuit 11 of the full-bridge converter. Thus, the capacitor 10 can cut a DC component, and the transformer 9 can perform an impedance conversion. At this time, the impedance conversion can equivalently increase the capacity of the capacitor 10. As a result, it is possible to equally control application periods of the positive half-wave and the negative half-wave in the full-bridge converter. Accordingly, it is possible to prevent a biased excitation in the main transformer 5, and to stably operate the power supply device like a full-bridge converter.

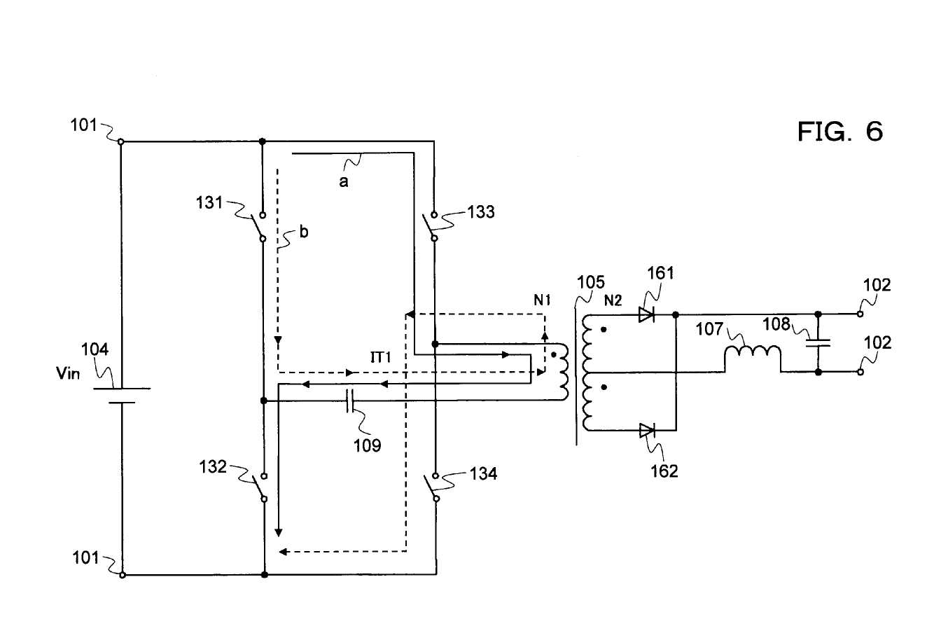

FIG. 4 mainly shows waveforms of the power supply device in FIG. 1. In particular, FIG. 4A shows waveforms in the case that the power supply device in FIG. 6 is normally operated, FIG. 4B shows waveforms in the case that the capacitor 109 is omitted in the power supply device in FIG. 6, and FIG. 4C shows waveforms of the power supply device in FIG. 1.

In FIG. 4A, the capacitor 109 prevents a biased excitation in the main transformer 105. As a result, in the input waveforms from the power supply 104, a pulse width t1 on a positive side (an application period of the positive half-wave in one cycle) is equal to a pulse width t2 on a negative side (an application period of the negative half-wave in one cycle), and a current I_{T1} which flows through the primary winding N1 of the main transformer 105 becomes a normal waveform according to the input waveforms. The waveform indicates that the capacitor 109 can prevent a biased excitation in the main transformer 105 in a power supply device with not a large capacity.

On the other hand, in FIG. 4B, since the capacitor 109 is omitted, a biased excitation in the main transformer 105 occurs. That is, in the input waveforms from the power supply 104, the pulse width t1 on the positive side is not equal to the pulse width t2 on the negative side, and the current I_{T1} which flows through the primary winding N1 of the main transformer 105 becomes an abnormal waveform according to the input waveforms. In this case, the main transformer 105 is saturated by the biased excitation, and finally destroyed by an overcurrent (shown by arrows).

This waveform is an example in the case of omitting the capacitor 109. However, in a power supply device which performs large capacity power conversion, the capacitor 109 cannot be applied (or connected) thereto, since a limit of a withstand voltage and a permissible ripple current of the capacitor 109. Then, a biased excitation in the main transformer 105 cannot be prevented.

On the contrary, in FIG. 4C, an amplitude of a current I_{T2-N1} (or current value) is larger than an amplitude of the current I_{T1} which flows to the capacitor 109 in FIG. 4A. That is, this waveform shows a waveform in a large capacity power supply device (waveform of a high current). However, an amplitude of a current I_{T2-N2} which flows through the secondary winding N2′ of the transformer 9 (then flows to the capacitor 10) is suppressed compared with the amplitude of the current I_{T2-N1}. That is, due to the impedance conversion circuit 13, a current value which flows to the capacitor 10 is suppressed to such a small value. Thus, the capacitor 10 can certainly cut a DC component.

As a result, in input waveforms from the power supply 4, a pulse width t1 on a positive side is equal to a pulse width t2 on a negative side (not shown). It may be considered that the input waveforms from the power supply 4 is similar with the input waveforms in FIG. 4A, and only an amplitude thereof is larger. Additionally, the current I_{T2-N1} which flows through the primary winding N1′ of the transformer 9 has a normal waveform according to the input waveforms. Thus, the waveform indicates that the impedance conversion circuit 13 of one embodiment of the present invention prevents a biased excitation in the main transformer 5.

As understood by the above description, even the capacitor 10 having a permissible ripple current which is not so large can prevent a biased excitation in the main transformer 5. Accordingly, it is possible to realize a large capacity power supply device which can prevent a biased excitation in the main transformer 5 by using the capacitor 10.

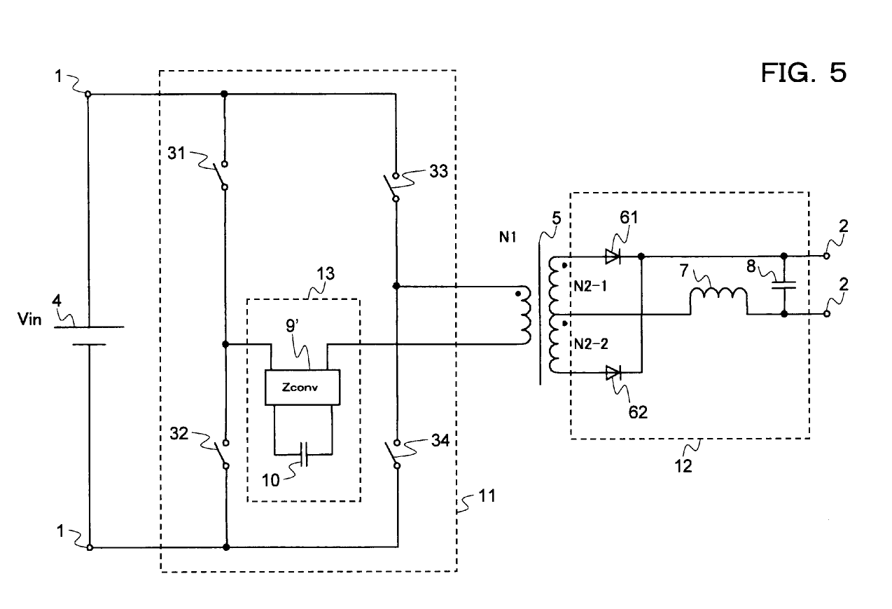

FIG. 5 is a diagram showing a structure of a power supply device of another embodiment of the present invention. In this embodiment, the transformer (or the current transformer) 9, which constitute the impedance conversion circuit 13, is replaced with an impedance converter (Zconv) 9′ which comprises semiconductor elements, in the power supply device of FIG. 1. And, the other structure is the same with the structure in FIG. 1. The impedance converter 9′ has a structure which converts an impedance, for example, by using semiconductor elements such as an operational amplifier or the like.

In the case that the impedance converter 9′ has a coefficient k of an impedance conversion, as shown in FIG. 2B, a relation between an equivalent impedance Z1 connected in series to the primary winding N1 of the a main transformer 5 and an equivalent impedance Z2 of the capacitor 10 is expressed by Z1=k·Z2. The coefficient k corresponds to (N1′/N2′)² in the case shown in FIG. 2A. Accordingly, even though a primary current of the main transformer 5 is large, an appropriate value of the coefficient k can reduce the primary current, supply it to the capacitor 10, and cut a DC component of the primary current. Then, similarly to the power supply device in FIG. 1, it is possible to prevent the biased excitation in the main transformer 5, and to stably operate the power supply device like a full-bridge converter. A power supply of the operational amplifier or the like may be generated, for example, as a local power supply by using a current which flows from the main transformer 5 to the impedance converter 9′.

The present invention is described according to embodiments thereof. However, various changes can be made within the scope of the present invention.

For example, in the embodiments of FIGS. 1 and 5, the impedance conversion circuit 13 is connected between one terminal of the primary winding N1 of the main transformer 5 and the connection point of the semiconductor switches 31 and 32. Instead, the impedance conversion circuit 13 may be connected between the other terminal of the primary winding N1 of the main transformer 5 and the connection point of the semiconductor switches 33 and 34. That is, it is acceptable when the impedance conversion circuit 13 is connected in series to the primary winding N1 of the main transformer 5.

Additionally, one embodiment of the present invention can be applied to not only full-bridge converters shown in FIGS. 1 and 5, but also various types of switching converters such as push-pull converters, and various types of power supply devices in which DC components is cut by using capacitors.

As described above, according to the present embodiments, in a power supply device and a power supply control method, an impedance conversion circuit can be prevent a biased excitation in a main transformer, even though a large current flows through a primary winding of the main transformer. Then, a large capacity power supply device which prevents the biased excitation in the main transformer can be realized. In particular, according to the present embodiments, the capacity of the capacitor in the case of viewing from the primary side in the main transformer can be made equivalently large. Therefore, even the capacitor having a permissible ripple current which is not so large can prevent the biased excitation in a large capacity power supply device. Thus, it is possible to realize a large capacity power supply device which prevents the biased excitation in the main transformer by using the capacitor.

What is claimed is:

1. A power supply device comprising:
an input terminal;
an output terminal;
a main transformer having a primary winding and a secondary winding;
a primary circuit connected between the input terminal and the primary winding of the main transformer;
a secondary circuit connected between the secondary winding of the main transformer and the output terminal; and
an impedance conversion circuit provided in the primary circuit, connected in series to the primary winding of the main transformer, and having a function reducing a current flowing in the impedance conversion circuit and a function cutting a DC component included in the reduced current.

2. The power supply device according to claim 1, wherein the impedance conversion circuit comprises a transformer or a current transformer having a primary winding which is connected in series to the primary winding of the main transformer, and a capacitor connected in series to a secondary winding of the transformer or a current transformer.

3. The power supply device according to claim 2, wherein the transformer or current transformer comprises a transformer, and an equivalent capacity of the capacitor is determined by a turns ratio of the primary winding to the secondary winding of the transformer.

4. The power supply device according to claim 2, wherein the transformer or current transformer comprises an impedance converter which comprises semiconductor elements.

5. The power supply device according to claim 1, wherein the primary circuit comprises a bridge circuit which comprises semiconductor elements.

6. The power supply device according to claim 5,
wherein the primary circuit comprises a bridge circuit which comprises a first to a fourth semiconductor switches, and
wherein one terminal of the primary winding of the main transformer is connected to a connection point of the first and the second semiconductor switches which are connected in series through the impedance conversion circuit, and the other terminal of the primary winding of the main transformer is connected to a connection point of the third and the fourth semiconductor switches which are connected in series.

7. A power supply control method in a power supply device having a primary circuit connected between an input terminal and a primary winding of a main transformer, a secondary circuit connected between a secondary winding of the main transformer and an output terminal, and an impedance conversion circuit provided in the primary circuit and connected in series to the primary winding of the main transformer, the method comprising:
reducing, when a current flows from the primary winding of the main transformer to the impedance conversion circuit, by the impedance conversion circuit a current flowing therein; and
cutting a DC component included in the reduced current.
